(19) United States
(12) Patent Application Publication
(10) Pub. No.: US 2018/0357945 A1
(43) Pub. Date: Dec. 13, 2018

(54) OPTICAL COMPENSATION APPARATUS APPLIED TO PANEL AND OPERATING METHOD THEREOF

(71) Applicant: Raydium Semiconductor Corporation, Hsinchu (TW)

(72) Inventors: Shang-Ping TANG, Zhubei City (TW); Hung LI, Taipei City (TW)

(21) Appl. No.: 16/002,175

(22) Filed: Jun. 7, 2018

Related U.S. Application Data
(60) Provisional application No. 62/517,193, filed on Jun. 9, 2017.

(51) Int. Cl. G09G 3/20; G09G 3/3225

(52) U.S. Cl. CPC G09G 3/2003; G09G 3/3225; G09G 2320/0233; G09G 2320/0666; G09G 2360/145

(57) ABSTRACT

An optical compensation apparatus applied to a panel is disclosed. The panel includes sub-pixels for displaying a display data. The optical compensation apparatus includes an optical measurement module, a data processing module and an optical compensation module. The optical measurement module measures optical measurement values corresponding to the sub-pixels. The data processing module determines first optical compensation values needed for the sub-pixels according to the optical measurement values respectively, divides the sub-pixels into optical compensation regions according to at least one threshold compensation value and the first optical compensation values, and then generates second optical compensation values corresponding to the optical compensation regions respectively. The optical compensation module outputs the second optical compensation values to perform optical compensation on the display data.

### BACKGROUND OF THE INVENTION

### 1. Field of the Invention

The invention relates to a panel; in particular, to an optical compensation apparatus applied to the panel and an operating method thereof.

### 2. Description of the Prior Art

Current organic light-emitting diode (OLED) panels often suffer from mura and affect their yield. The so-called “mura” refers to various traces caused by non-uniform brightness of the panel. Since the mura generally exists on the background of non-uniform light source, it is impossible for the human eye to effectively distinguish between normal image and mura. As a result, many techniques for correcting mura have emerged.

A common demura method at present is to firstly measure the brightness of each sub-pixel of the panel to determine whether each sub-pixel has mura, and then to change the data signal outputted to each sub-pixel of the panel accordingly and then achieve the effect of lightness compensation.

However, the severity of mura may be different in different regions of the entire panel. Once the severity of mura in different regions is very different, if the same demura algorithm is used on the entire panel, only the mura in some regions of the panel can be eliminated, it still fails to completely eliminate all mura exists on the panel.

### SUMMARY OF THE INVENTION

Therefore, the invention provides an optical compensation apparatus applied to the panel and an operating method thereof to solve the above-mentioned problems of the prior arts.

A preferred embodiment of the invention is an optical compensation apparatus. In this embodiment, the optical compensation apparatus is applied to a panel. The panel includes a plurality of sub-pixels for displaying a display data. The optical compensation apparatus includes an optical measurement module, a data processing module and an optical compensation module. The optical measurement module is used for measuring a plurality of optical measurement values corresponding to the plurality of sub-pixels of the panel. The data processing module is coupled to the optical measurement module and used for determining first optical compensation values needed for the sub-pixels according to the optical measurement values respectively, dividing the sub-pixels into optical compensation regions according to at least one threshold compensation value and the first optical compensation values, and then generating second optical compensation values corresponding to the optical compensation regions respectively. The optical compensation module is coupled to the data processing module and used for outputting the second optical compensation values to perform optical compensation on the display data.

In an embodiment, the panel is an organic light-emitting diode (OLED) panel.

In an embodiment, the plurality of optical measurement values is lightness values of the plurality of sub-pixels.

In an embodiment, the optical measurement module includes a control unit, an optical sensing unit and a data accessing unit. The control unit is used for providing a control signal. The optical sensing unit is coupled to the control unit and used for performing optical sensing on the plurality of sub-pixels of the panel according to the control signal to obtain the plurality of optical measurement values. The data accessing unit is coupled to the optical sensing unit and used for accessing the plurality of optical measurement values from the optical measuring unit.

In an embodiment, the data processing module includes a data analyzing unit, a data processing unit, a partition unit and a selection unit. The data analyzing unit is coupled to the optical measurement module used for receiving and analyzing the plurality of optical measurement values. The data processing unit is coupled to the data analyzing unit and used for determining the first optical compensation values needed for the sub-pixels according to the optical measurement values respectively. The partition unit is coupled to the data processing unit and used for dividing the sub-pixels into the optical compensation regions according to the at least one threshold compensation value and the first optical compensation values. The selection unit is coupled to the partition unit and used for selecting a plurality of demura modes corresponding to the optical compensation regions respectively and generating the second optical compensation values corresponding to the optical compensation regions according to the plurality of demura modes respectively.

In an embodiment, the optical compensation module and the panel are both coupled to a display driving apparatus, and the display driving apparatus receives the display data and the plurality of second optical compensation values respectively and performs optical compensation on the display data according to the plurality of second optical compensation values and then outputs the optical compensated display data to the panel.

In an embodiment, the at least one threshold compensation value is adjustable.

In an embodiment, an optical compensation region of the plurality of optical compensation regions is a single region.

In an embodiment, an optical compensation region of the plurality of optical compensation regions is formed by a plurality of sub-regions.

In an embodiment, the plurality of sub-regions has the same shape and area or has different shapes and areas.

Another preferred embodiment of the invention is an optical compensation apparatus operating method. In this embodiment, the optical compensation apparatus operating method is used for operating an optical compensation apparatus applied to a panel including a plurality of sub-pixels for displaying a display data. The optical compensation apparatus operating method includes steps of: (a) measuring a plurality of optical measurement values corresponding to the plurality of sub-pixels of the panel; (b) determining first optical compensation values needed for the sub-pixels according to the optical measurement values respectively; (c) dividing the sub-pixels into optical compensation regions according to at least one threshold compensation value and the first optical compensation values; (d) generating second optical compensation values corresponding to the optical compensation regions respectively; and (e) outputting the second optical compensation values for performing optical compensation on the display data.

Compared to the prior art, even if the severity of mura varies greatly in different regions of the panel, the optical compensation apparatus and the operating method thereof according to the invention can grade the severity of mura exists on all sub-pixels of the panel at first and then divide all sub-pixels of the panel into optical compensation regions and use different suitable demura modes to perform optical compensation on the optical compensation regions. Therefore, the mura on all regions of the entire panel can be completely eliminated to achieve the optimized demura effect instead of only eliminating the mura on some regions of the panel as the prior art, so that the display quality of the panel can be enhanced and the visual experience of the user can be also improved.

The advantage and spirit of the invention may be understood by the following detailed descriptions together with the appended drawings.

### BRIEF DESCRIPTION OF THE APPENDED DRAWINGS

FIG. 1 illustrates a schematic diagram of an optical compensation apparatus applied to a panel in a preferred embodiment of the invention.

FIG. 2 illustrates a schematic diagram of the mura having different seventies appeared on the panel.

FIG. 3 and FIG. 4 illustrate different embodiments of dividing the panel PL into optical compensation regions RG1˜RG3 according to the positions of the mura MR3˜MR4 appeared on the panel PL respectively.

FIG. 5 and FIG. 6 illustrate different embodiments of using different demura modes to perform optical compensation on the optical compensation regions RG1˜RG3 respectively.

FIG. 7 illustrates a flowchart of an optical compensation apparatus operating method in another embodiment of the invention.

### DETAILED DESCRIPTION OF THE INVENTION

The invention discloses an optical compensation apparatus and an operating method thereof. In practical applications, even if the severity of mura varies greatly in different regions of the panel, the optical compensation apparatus and the operating method thereof according to the invention can grade the severity of mura exists on all sub-pixels of the panel at first and then divide all sub-pixels of the panel into optical compensation regions and use different suitable demura modes to perform optical compensation on different optical compensation regions respectively. Therefore, the mura on all regions of the entire panel can be completely eliminated to achieve the optimized demura effect.

A preferred embodiment of the invention is an optical compensation apparatus. In this embodiment, the optical compensation apparatus is applied to a panel (e.g., an OLED panel), but not limited to this. The panel includes a plurality of sub-pixels for displaying a display data.

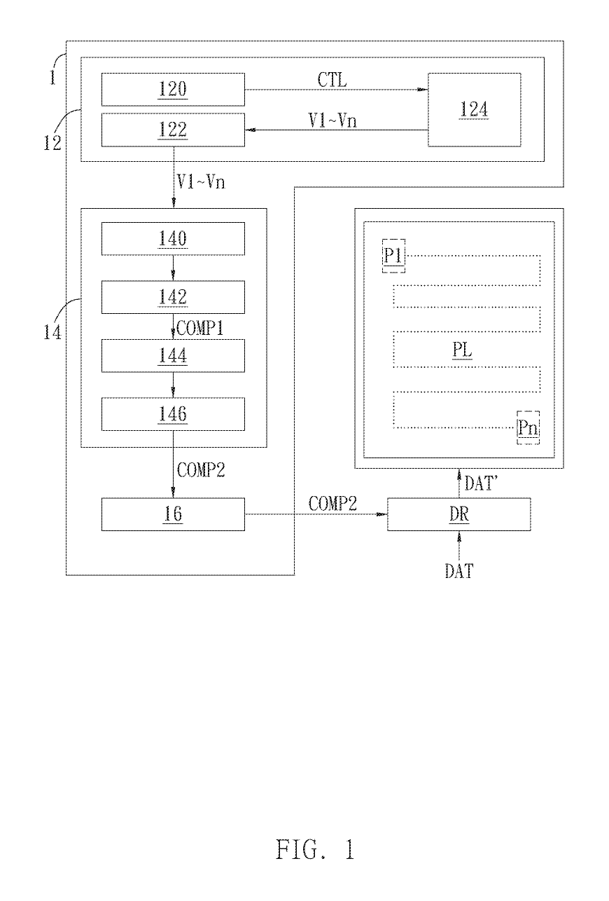

Please refer to FIG. 1. FIG. 1 illustrates a schematic diagram of an optical compensation apparatus applied to a panel in this embodiment.

As shown in FIG. 1, the optical compensation apparatus 1 is disposed corresponding to the panel PL, and the optical compensation apparatus 1 and the panel PL are coupled to a display driving apparatus DR. The display driving apparatus DR is used for receiving a display data DAT and outputting the display data DAT to the sub-pixels P1˜Pn of the panel PL for displaying, wherein n is a positive integer larger than 1.

The optical compensation apparatus 1 includes an optical measurement module 12, a data processing module 14 and an optical compensation module 16. The data processing module 14 is coupled to the optical measurement module 12; the optical compensation module 16 is coupled to the data processing module 14 and the optical compensation module 16 is also coupled to the display driving apparatus DR.

The optical measurement module 12 is disposed corresponding to the panel PL and used for measuring a plurality of optical measurement values V1˜Vn (e.g., the lightness, but not limited to this) corresponding to the plurality of sub-pixels P1˜Pn of the panel PL respectively.

In this embodiment, the optical measurement module 12 can include a control unit 120, a data accessing unit 122 and an optical sensing unit 124. The control unit 120 and the data accessing unit 122 are both coupled to the optical sensing unit 124.

When the control unit 120 provides a control signal CTL to the optical sensing unit 124, the optical sensing unit 124 will perform optical sensing on the plurality of sub-pixels P1˜Pn of the panel PL according to the control signal CTL to obtain the plurality of optical measurement values V1˜Vn corresponding to the plurality of sub-pixels P1˜Pn.

Then, the data accessing unit 122 will access the plurality of optical measurement values V1˜Vn from the optical measuring unit 124 and transmit the plurality of optical measurement values V1˜Vn to the data processing module 14. In practical applications, the optical measuring unit 124 can be optical lens or any other device having the optical measuring function, but not limited to this.

When the data processing module 14 receives the plurality of optical measurement values V1˜Vn, the data processing module 14 will determine first optical compensation values COMP1 needed for the sub-pixels P1˜Pn according to the optical measurement values V1˜Vn respectively.

Then, the data processing module 14 will divide the sub-pixels P1˜Pn of the panel PL into optical compensation regions according to at least one threshold compensation value and the first optical compensation values COMP1.

Afterward, the data processing module 14 will select a plurality of demura modes corresponding to the plurality of optical compensation regions respectively and generate second optical compensation values corresponding to the optical compensation regions according to the plurality of demura modes respectively. In practical applications, the plurality of demura modes can correspond to different demura algorithms respectively, but not limited to this.

In this embodiment, the data processing module 14 can include a data analyzing unit 140, a data processing unit 142, a partition unit 144 and a selection unit 146. The data analyzing unit 140 is coupled to the optical measurement module 12; the data processing unit 142 is coupled to the data analyzing unit 140; the partition unit 144 is coupled to the data processing unit 142; the selection unit 146 is coupled to the partition unit 144 and the optical compensation module 16.

The data analyzing unit 140 is used for receiving and analyzing the plurality of optical measurement values V1˜Vn. The data processing unit 142 is used for determining the first optical compensation values COMP1 needed for the sub-pixels P1˜Pn according to the optical measurement values V1˜Vn respectively and transmitting the first optical compensation values COMP1 to the partition unit 144.

The partition unit 144 is used for dividing the sub-pixels P1˜Pn of the panel PL into the optical compensation regions according to the at least one threshold compensation value and the first optical compensation values COMP1. The selection unit 146 is used for selecting a plurality of demura modes corresponding to the optical compensation regions respectively and generating the second optical compensation values COMP2 corresponding to the optical compensation regions according to the plurality of demura modes respectively and then transmitting the second optical compensation values COMP2 to the optical compensation module 16.

The optical compensation module 16 is used for outputting the second optical compensation values COMP2 to the display driving apparatus DR, and the display driving apparatus DR can perform optical compensation on the display data DAT according to the second optical compensation values COMP2 to generate an optically compensated display data DAT′. And then, the display driving apparatus DR will output the optically compensated display data DAT′ to the panel PL for displaying.

It should be noticed that the at least one threshold compensation value used by the partition unit 144 is adjustable. Therefore, the number and value of the at least one threshold compensation value can be determined based on practical needs and the device operation capability.

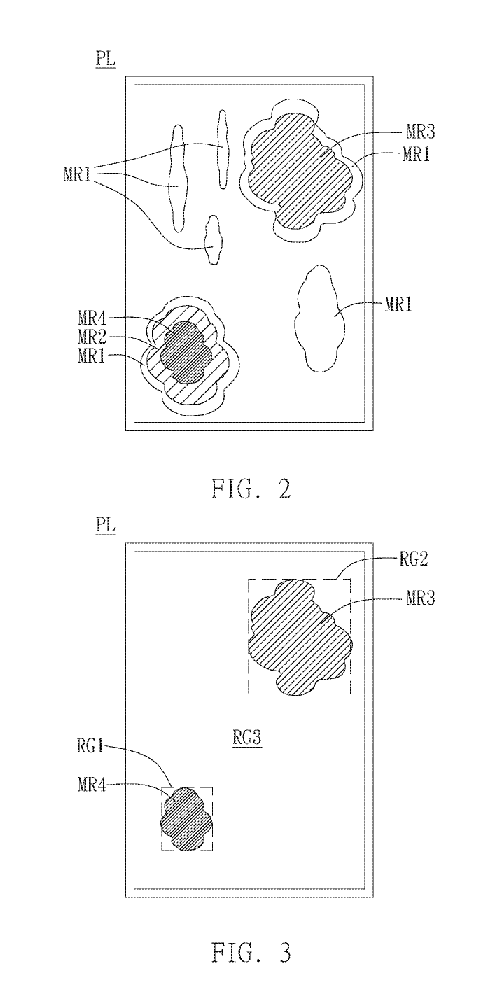

For example, as shown in FIG. 2, it is assumed that the mura MR1, the mura MR2, the mura MR3 and the mura MR4 having different seventies are appeared on the panel respectively, wherein the order of the seventies of the mura MR1, the mura MR2, the mura MR3 and the mura MR4 from high to low are: the mura MR4, the mura MR3, the mura MR2 and the mura MR1.

After the data processing unit 142 determines the first optical compensation values COMP1 needed for the sub-pixels according to the optical measurement values V1˜Vn measured from the panel PL respectively, the partition unit 144 can divide the sub-pixels P1˜Pn of the panel PL into the optical compensation regions according to the at least one threshold compensation value and the first optical compensation values COMP1.

For example, it is assumed that the at least one threshold compensation value used by the partition unit 144 includes a first threshold compensation value and a second threshold compensation value, and the second threshold compensation value is larger than the first threshold compensation value.

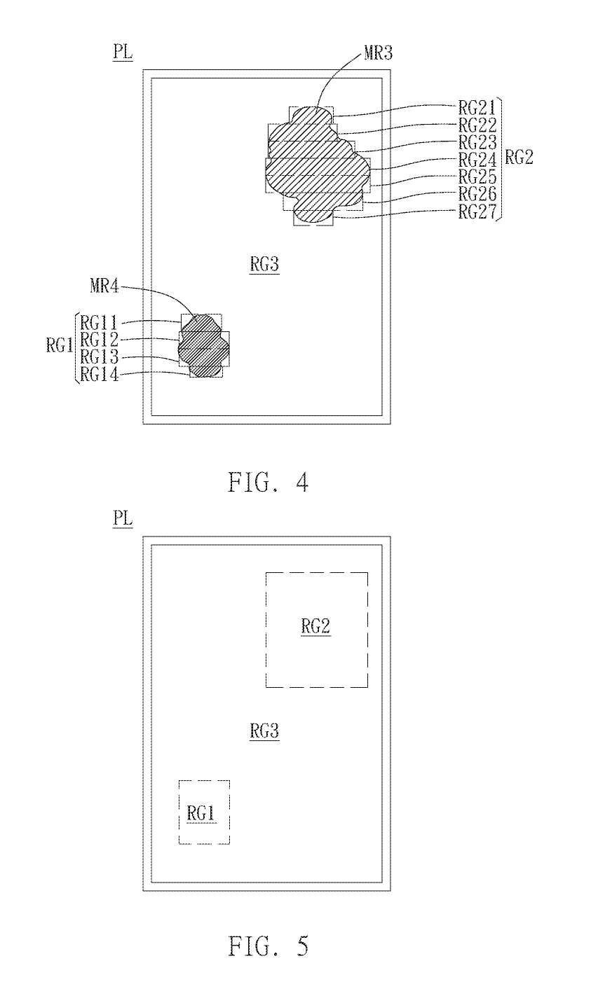

If the first optical compensation values COMP1 of the sub-pixels corresponding to the mura MR1 and the mura MR2 in FIG. 2 are smaller than the first threshold compensation value, it means that the mura MR1 and the mura MR2 are less severe, the partition unit 144 will divide the sub-pixels corresponding to the mura MR1 and the mura MR2 into a third optical compensation region RG3 as shown in FIG. 3.

It should be noticed that since the first optical compensation values COMP1 of the sub-pixels without mura are also smaller than the first threshold compensation value, these sub-pixels will be also divided into the third optical compensation region RG3 as shown in FIG. 3.

If the first optical compensation values COMP1 of the sub-pixels corresponding to the mura MR3 in FIG. 2 are larger than the first threshold compensation value but smaller than the second threshold compensation value, it means that the mura MR3 is moderate in severity, the partition unit 144 will divide the sub-pixels corresponding to the mura MR3 into a second optical compensation region RG2 as shown in FIG. 3.

If the first optical compensation values COMP1 of the sub-pixels corresponding to the mura MR4 in FIG. 2 are larger than the second threshold compensation value, it means that the mura MR4 is high in severity, the partition unit 144 will divide the sub-pixels corresponding to the mura MR4 into a first optical compensation region RG1 as shown in FIG. 3.

That is to say, in this embodiment, the partition unit 144 grades the first optical compensation values COMP1 of all sub-pixels P1˜Pn of the panel PL according to the first threshold compensation value and the second threshold compensation value and then divides the sub-pixels P1˜Pn of the panel PL into the first optical compensation region RG1˜the third optical compensation region RG3 according to different seventies of mura, but not limited to this.

Different from the first optical compensation region RG1 and the second optical compensation region RG2 only including a single region, in another embodiment, as shown in FIG. 4, the first optical compensation region RG1 can include sub-regions RG11˜RG14 and the second optical compensation region RG2 can include sub-regions RG21˜RG27, so that the shapes and the areas of the first optical compensation region RG1 and the second optical compensation region RG2 can be more similar to the shapes and the areas of the mura MR3 and the mura MR4, but not limited to this.

It should be noticed that the number and the value of the at least one threshold compensation value used by the partition unit 144 and the number, the shapes and the areas of the sub-regions included by the optical compensation regions can be adjusted based on practical needs and apparatus processing capability without specific limitations.

After the partition unit 144 divides the panel PL into the first optical compensation region RG1˜the third optical compensation region RG3, the selection unit 146 will select different demura modes suitable for the first optical compensation region RG1˜the third optical compensation region RG3 respectively, generate the second optical compensation values COMP2 corresponding to the first optical compensation region RG1˜the third optical compensation region RG3 respectively and then transmit the second optical compensation values COMP2 to the optical compensation module 16. In practical applications, different demura modes can correspond to different demura algorithms respectively to provide different demura effects, but not limited to this.

Then, the optical compensation module 16 transmits the second optical compensation values COMP2 corresponding to the first optical compensation region RG1˜the third optical compensation region RG3 to the display driving apparatus DR, so that the display driving apparatus DR can perform optical compensation on a part of the display data DAT corresponding to the first optical compensation region RG1˜the third optical compensation region RG3 according to the second optical compensation values COMP2 respectively to generate the optical compensated display data DAT′, and then the display driving apparatus DR can output the optical compensated display data DAT′ to the panel PL for displaying. Therefore, the mura in all optical compensation regions can be effectively eliminated to achieve the optimized demura effect.

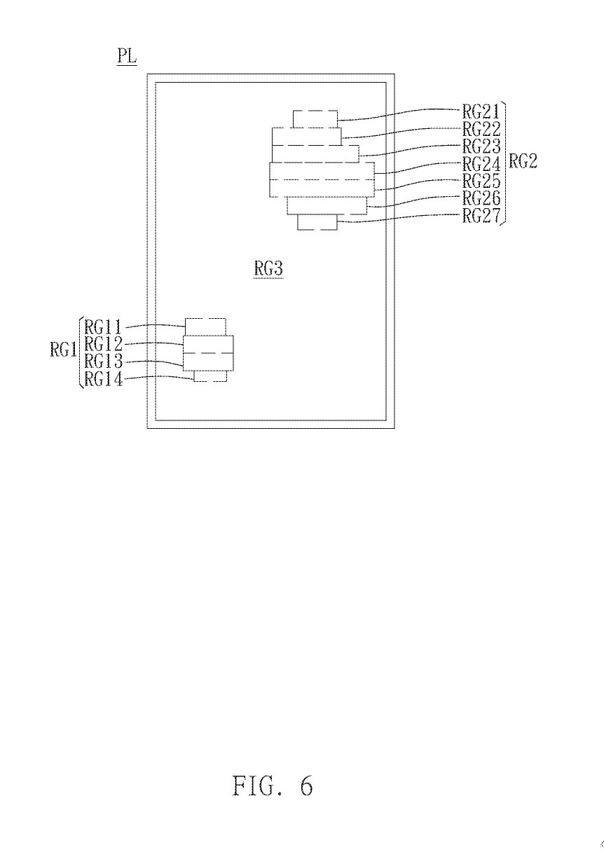

For example, the order of the mura seventies of the first optical compensation region RG1˜the third optical compensation region RG3 from high to low is: the first optical compensation region RG1, the second optical compensation region RG2 and the third optical compensation region RG3; therefore, as shown in FIG. 5, in order to effectively eliminate the mura in all optical compensation regions, the selection unit 146 will select the demura mode having stronger demura capability for the first optical compensation region RG1, select the demura mode having middle demura capability for the second optical compensation region RG2 and select the demura mode having weaker demura capability for the third optical compensation region RG3 to generate the second optical compensation values COMP2 corresponding to the first optical compensation region RG1˜the third optical compensation region RG3 respectively, so that the display driving apparatus DR can perform optical compensation on a part of the display data DAT corresponding to the first optical compensation region RG1˜the third optical compensation region RG3 according to the second optical compensation values COMP2 respectively to generate the optical compensated display data DAT′ to the panel PL for displaying to achieve the optimized demura effect.

Similarly, the order of the mura seventies of the first optical compensation region RG1˜the third optical compensation region RG3 from high to low is: the first optical compensation region RG1, the second optical compensation region RG2 and the third optical compensation region RG3; therefore, as shown in FIG. 6, in order to effectively eliminate the mura in all optical compensation regions, the selection unit 146 will select the demura mode having stronger demura capability for the first optical compensation region RG1, select the demura mode having middle demura capability for the second optical compensation region RG2 and select the demura mode having weaker demura capability for the third optical compensation region RG3 to generate the second optical compensation values COMP2 corresponding to the first optical compensation region RG1˜the third optical compensation region RG3 respectively, so that the display driving apparatus DR can perform optical compensation on a part of the display data DAT corresponding to the first optical compensation region RG1˜the third optical compensation region RG3 according to the second optical compensation values COMP2 respectively to generate the optical compensated display data DAT′ to the panel PL for displaying to achieve the optimized demura effect.

Another preferred embodiment of the invention is an optical compensation apparatus operating method. In this embodiment, the optical compensation apparatus operating method is used for operating an optical compensation apparatus applied to a panel including a plurality of sub-pixels for displaying a display data.

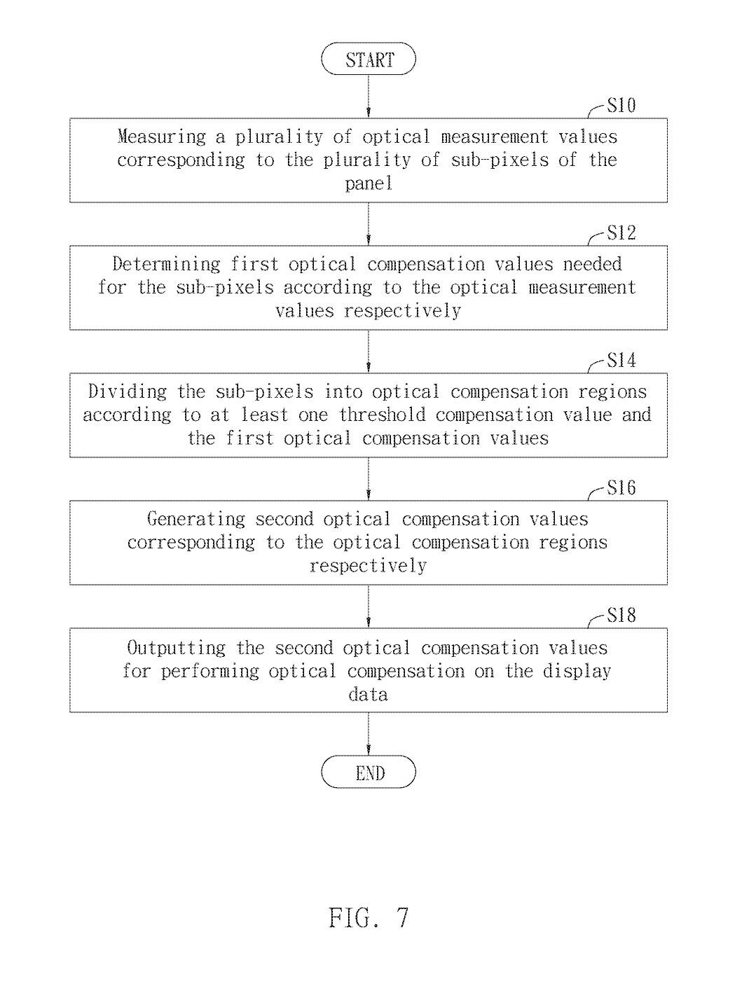

Please refer to FIG. 7. FIG. 7 illustrates a flowchart of the optical compensation apparatus operating method in this embodiment. As shown in FIG. 7, the optical compensation apparatus operating method includes following steps.

Step S10: Measuring a plurality of optical measurement values corresponding to the plurality of sub-pixels of the panel (e.g., the lightness values of the sub-pixels, but not limited to this).

Step S12: Determining first optical compensation values needed for the sub-pixels according to the optical measurement values respectively.

Step S14: Dividing the sub-pixels into optical compensation regions according to at least one threshold compensation value and the first optical compensation values.

Step S16: Generating second optical compensation values corresponding to the optical compensation regions respectively.

Step S18: Outputting the second optical compensation values for performing optical compensation on the display data.

Compared to the prior art, even if the severity of mura varies greatly in different regions of the panel, the optical compensation apparatus and the operating method thereof according to the invention can grade the severity of mura exists on all sub-pixels of the panel at first and then divide all sub-pixels of the panel into optical compensation regions and use different suitable demura modes to perform optical compensation on the optical compensation regions. Therefore, the mura on all regions of the entire panel can be completely eliminated to achieve the optimized demura effect instead of only eliminating the mura on some regions of the panel as the prior art, so that the display quality of the panel can be enhanced and the visual experience of the user can be also improved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An optical compensation apparatus, applied to a panel comprising a plurality of sub-pixels for displaying a display data, the optical compensation apparatus comprising:
an optical measurement module, for measuring a plurality of optical measurement values corresponding to the plurality of sub-pixels of the panel;
a data processing module, coupled to the optical measurement module, for determining first optical compensation values needed for the plurality of sub-pixels according to the plurality of optical measurement values respectively, dividing the plurality of sub-pixels into a plurality of optical compensation regions according to at least one threshold compensation value and the plurality of first optical compensation values, and then generating a plurality of second optical compensation values corresponding to the plurality of optical compensation regions respectively; and
an optical compensation module, coupled to the data processing module, for outputting the plurality of second optical compensation values to perform optical compensation on the display data.

2. The optical compensation apparatus of claim 1, wherein the panel is an organic light-emitting diode (OLED) panel.

3. The optical compensation apparatus of claim 1, wherein the plurality of optical measurement values is lightness values of the plurality of sub-pixels.

4. The optical compensation apparatus of claim 1, wherein the optical measurement module comprises:
a control unit, for providing a control signal;
an optical sensing unit, coupled to the control unit, for performing optical sensing on the plurality of sub-pixels of the panel according to the control signal to obtain the plurality of optical measurement values; and
a data accessing unit, coupled to the optical sensing unit, for accessing the plurality of optical measurement values from the optical measuring unit.

5. The optical compensation apparatus of claim 1, wherein the data processing module comprises:
a data analyzing unit, coupled to the optical measurement module, for receiving and analyzing the plurality of optical measurement values;
a data processing unit, coupled to the data analyzing unit, for determining the first optical compensation values needed for the plurality of sub-pixels according to the plurality of optical measurement values respectively;
a partition unit, coupled to the data processing unit, for dividing the plurality of sub-pixels into the plurality of optical compensation regions according to the at least one threshold compensation value and the plurality of first optical compensation values; and
a selection unit, coupled to the partition unit, for selecting a plurality of demura modes corresponding to the plurality of optical compensation regions respectively and generating the plurality of second optical compensation values corresponding to the plurality of optical compensation regions according to the plurality of demura modes respectively.

6. The optical compensation apparatus of claim 1, wherein the optical compensation module and the panel are both coupled to a display driving apparatus, and the display driving apparatus receives the display data and the plurality of second optical compensation values respectively and performs optical compensation on the display data according to the plurality of optical compensation values and then outputs the optical compensated display data to the panel.

7. The optical compensation apparatus of claim 1, wherein the at least one threshold compensation value is adjustable.

8. The optical compensation apparatus of claim 1, wherein an optical compensation region of the plurality of optical compensation regions is a single region.

9. The optical compensation apparatus of claim 1, wherein an optical compensation region of the plurality of optical compensation regions is formed by a plurality of sub-regions.

10. The optical compensation apparatus of claim 9, wherein the plurality of sub-regions has the same shape and area or has different shapes and areas.

11. An optical compensation apparatus operating method, for operating an optical compensation apparatus applied to a panel comprising a plurality of sub-pixels for displaying a display data, the optical compensation apparatus operating method comprising steps of:
(a) measuring a plurality of optical measurement values corresponding to the plurality of sub-pixels of the panel;
(b) determining first optical compensation values needed for the plurality of sub-pixels according to the plurality of optical measurement values respectively;
(c) dividing the plurality of sub-pixels into a plurality of optical compensation regions according to at least one threshold compensation value and the plurality of first optical compensation values;
(d) generating a plurality of second optical compensation values corresponding to the plurality of optical compensation regions respectively; and
(e) outputting the plurality of second optical compensation values to perform optical compensation on the display data.

12. The optical compensation apparatus operating method of claim 11, wherein the panel is an organic light-emitting diode (OLED) panel.

13. The optical compensation apparatus operating method of claim 11, wherein the plurality of optical measurement values is lightness values of the plurality of sub-pixels.

14. The optical compensation apparatus operating method of claim 11, wherein the at least one threshold compensation value is adjustable.

15. The optical compensation apparatus operating method of claim 11, wherein an optical compensation region of the plurality of optical compensation regions is a single region.

16. The optical compensation apparatus operating method of claim 11, wherein an optical compensation region of the plurality of optical compensation regions is formed by a plurality of sub-regions.

17. The optical compensation apparatus operating method of claim 16, wherein the plurality of sub-regions has the same shape and area or has different shapes and areas.
